(19) United States
(12) Patent Application Publication
(10) Pub. No.: US 2025/0037366 A1
(43) Pub. Date: Jan. 30, 2025

(54) ANATOMICALLY CONSTRAINED IMPLICIT SHAPE MODELS

(71) Applicant: DISNEY ENTERPRISES, INC., Burbank, CA (US)

(72) Inventors: Gaspard ZOSS, Zürich (CH); Prashanth CHANDRAN, Zürich (CH)

(21) Appl. No.: 18/780,259

(22) Filed: Jul. 22, 2024

Related U.S. Application Data
(60) Provisional application No. 63/515,264, filed on Jul. 24, 2023.

(51) Int. Cl. G06T 17/00

(52) U.S. Cl. CPC G06T 17/00

(57) ABSTRACT

One embodiment of the present invention sets forth a technique for generating a shape model. The technique includes generating, via execution of a set of neural networks based on a plurality of shapes associated with an object, a set of attributes associated with a set of anatomical constraints for the object. The technique also includes computing, based on the set of attributes, a set of positions of a set of points on the object. The technique further includes generating a three-dimensional (3D) model of the object based on the set of positions of the set of points.

### CROSS-REFERENCE TO RELATED APPLICATIONS

This application claims the benefit of the U.S. Provisional Application titled “Implicit Blendshapes for Object Remodeling, Retargeting and Tracking,” filed on Jul. 24, 2023, and having Ser. No. 63/515,264. The subject matter of this application is hereby incorporated herein by reference in its entirety.

### BACKGROUND

### Field of the Various Embodiments

Embodiments of the present disclosure relate generally to machine learning and computer vision and, more specifically, to anatomically constrained implicit shape models.

### Description of the Related Art

Realistic digital representations of faces, hands, bodies, and other recognizable objects are required for various computer graphics and computer vision applications. For example, digital representations of real-world deformable objects may be used in virtual scenes of film or television productions, video games, virtual worlds, and/or other environments and/or settings.

One technique for representing a digital shape involves using a data-driven parametric shape model to characterize realistic variations in the appearance of the shape. The data-driven parametric shape model is typically built from a dataset of scans of the same type of shape and represents a new shape as a combination of existing shapes in the dataset.

One common parametric shape model includes a linear three-dimensional (3D) morphable model (3DMM) that expresses new faces, bodies, and/or other shapes as linear combinations of prototypical basis shapes from a dataset. However, the linear 3D morphable model is unable to represent continuous, nonlinear deformations that are common to faces and other recognizable shapes. At the same time, linear combinations of input shapes generated by the linear 3D morphable model can lead to unrealistic motion or physically impossible shapes. For example, when a linear 3D morphable model is used to represent faces, the linear 3D morphable model may be unable to represent all possible face shapes and may also be capable of representing many non-face shapes.

To reduce the occurrence of non-face shapes in a 3DMM, anatomical constraints in the form of a skull, jaw bone, and skin patches sliding over the skull and jaw bone can be computed. These anatomical constraints can then be used to iteratively optimize 3DMM parameters that best describe the motions and/or deformations of the skin patches, skull, and jaw bone. The process can additionally be repeated for each frame of a facial performance to reconstruct and/or edit the 3D structure of the face during the facial performance. However, this iterative optimization-based approach typically requires several minutes to fit the 3DMM parameters to each frame of a facial performance. Consequently, optimization of 3DMM parameters based on anatomical constraints can significantly increase resource overhead and latency associated with facial animation and/or reconstruction.

As the foregoing illustrates, what is needed in the art are more effective techniques for representing digital shapes.

### SUMMARY

One embodiment of the present invention sets forth a technique for generating a shape model. The technique includes generating, via execution of a first set of neural networks based on a plurality of shapes associated with an object, a set of attributes associated with a set of anatomical constraints for the object. The technique also includes computing, based on the set of attributes, a set of positions of a set of points on the object. The technique further includes generating a three-dimensional (3D) model of the object based on the set of positions of the set of points.

One technical advantage of the disclosed techniques relative to the prior art is the ability to represent continuous, nonlinear deformations of shapes corresponding to faces and/or other objects. Consequently, the disclosed techniques can be used to generate shapes that reflect a wider range of facial expressions and/or other types of deformations of the shapes than conventional linear 3D morphable models (3DMMs) that express new shapes as linear combinations of prototypical basis shapes. Further, because the generated shapes adhere to anatomical constraints associated with the objects, the disclosed techniques can be used to generate shapes that are more anatomically plausible than those produced by 3DMMs. Another technical advantage of the disclosed techniques is the ability to generate anatomically plausible shapes more quickly and efficiently than conventional approaches that iteratively optimize 3DMM parameters using computed anatomical constraints. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the model learning module of FIG. 1, according to various embodiments.

FIG. 3 illustrates an example architecture for the anatomical implicit model of FIG. 2, according to various embodiments.

FIG. 4 illustrates an example set of training shapes for the anatomical implicit model of FIG. 2, according to various embodiments.

FIG. 5 is a flow diagram of method steps for generating a shape model, according to various embodiments.

FIG. 6 is a more detailed illustration of the model fitting module of FIG. 1, according to various embodiments.

FIG. 7 illustrates how the training engine of FIG. 6 trains a fitting model, according to various embodiments.

FIG. 8 illustrates an example set of fitted shapes associated with modifications to an anatomy of an object, according to various embodiments.

FIG. 9 is a flow diagram of method steps for fitting a shape model for an object to a set of constraints associated with a target shape, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

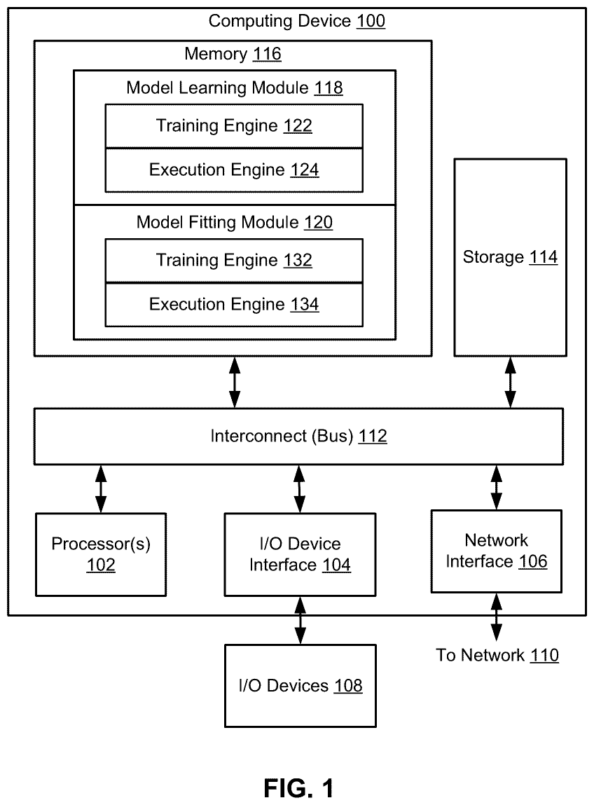

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a model learning module 118 and a model fitting module 120 that reside in a memory 116. Within memory 116, model learning module 118 includes a first training engine 122 and a first execution engine 124, and model fitting module 120 includes a second training engine 132 and a second execution engine 134.

It is noted that the computing device described herein is illustrative and that any other technically feasible configurations fall within the scope of the present disclosure. For example, multiple instances of model learning module 118, model fitting module 120, training engine 122, execution engine 124, training engine 132, and/or execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

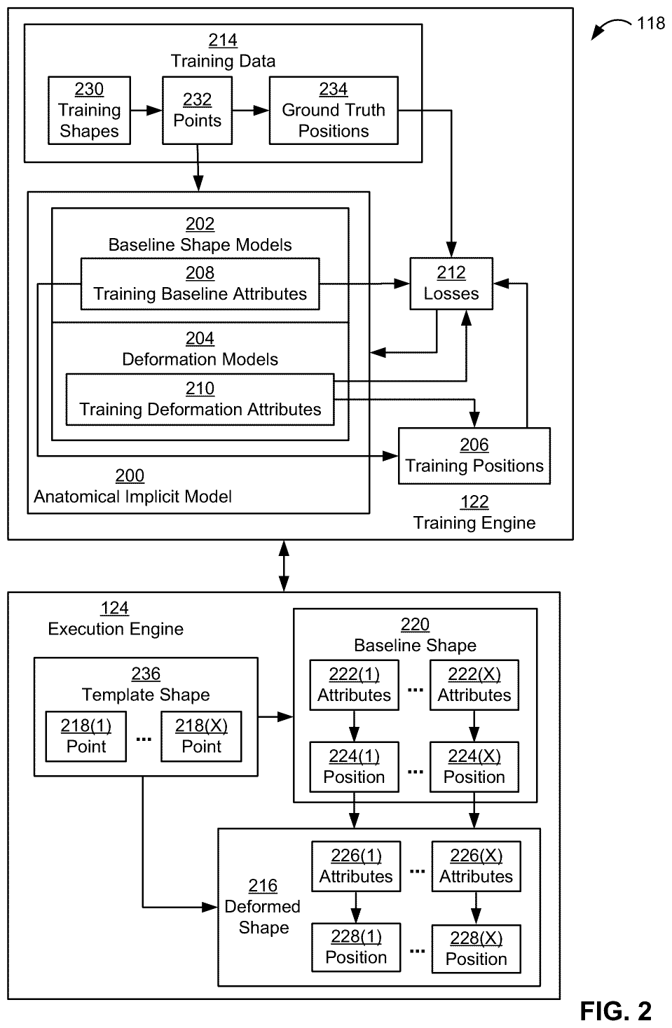

In some embodiments, model learning module 118 trains and executes an anatomical implicit model that learns a set of anatomical constraints associated with a face, body, hand, and/or another type of shape, given a set of three-dimensional (3D) geometries of the shape. For example, the anatomical implicit model may include one or more neural networks that are trained to predict, for a given point on a “baseline” shape (e.g., a face with a neutral expression), a bone point, a bone normal, a soft tissue thickness, and/or other attributes associated with the anatomy of the object. The anatomical implicit model may also include one or more neural networks and/or other types of machine learning models that predict skinning weights, corrective displacements, and/or other attributes that reflect a deformation of the baseline shape (e.g., a facial expression and/or blendshape). These parameters may then be used to displace the point to a new position corresponding to the deformation. After training of the anatomical implicit model is complete, the anatomical implicit model is capable of reproducing, on a per-point basis, the deformations in a way that constrains the surface of the shape to the underlying anatomy of the object. Model learning module 118 is described in further detail below with respect to FIGS. 2-5.

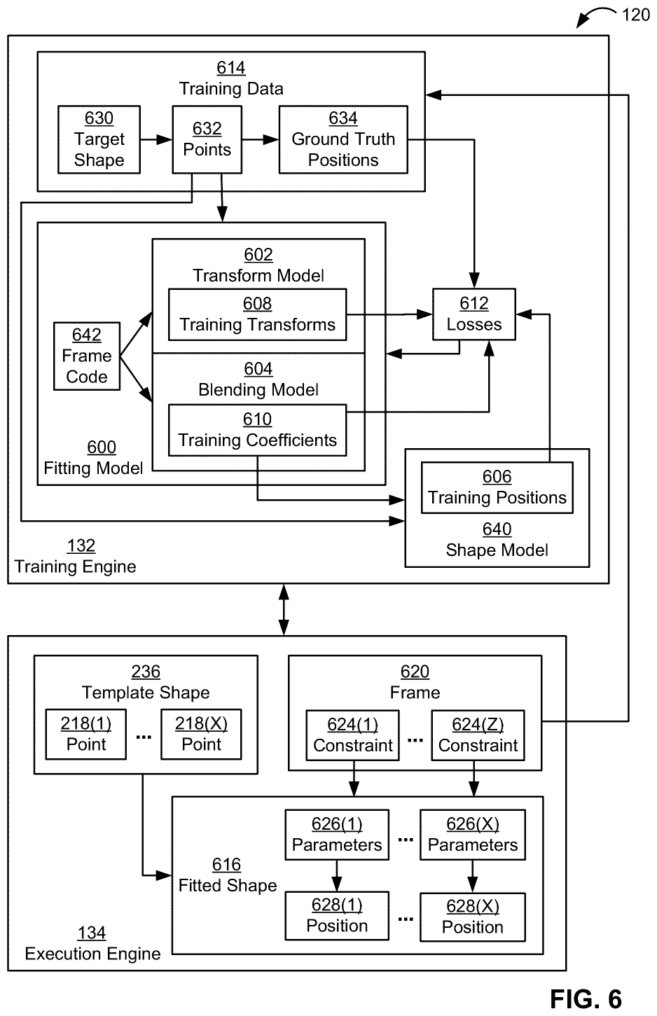

Model fitting module 120 executes one or more portions of the trained anatomical implicit model to generate and/or reconstruct additional shapes that adhere to the same anatomical constraints. More specifically, model fitting module 120 may “fit” the shapes learned by the anatomical implicit model to additional constraints such as (but not limited to) a 3D performance by the same object, a 3D performance by a different object, a two-dimensional (2D) position constraint (e.g., a facial landmark on an image), and/or edits to the geometry and/or anatomy of the object. During this fitting process, model fitting module 120 may use a fitting model that includes one or more neural networks and/or other types of machine learning models to predict head and/or jaw transformations, per-point blending coefficients, and/or other fitting parameters that are combined with per-point attributes outputted by the anatomical implicit model to generate a new shape for the object. Model fitting module 120 is described in further detail below with respect to FIGS. 6-9.

### Anatomically Constrained Implicit Shape Models

FIG. 2 is a more detailed illustration of model learning module 118 of FIG. 1, according to various embodiments. As mentioned above, model learning module 118 trains and executes an anatomical implicit model 200 to generate and/or reconstruct shapes that adhere to a set of anatomical constraints associated with an object. For example, model learning module 118 may use anatomical implicit model 200 to learn implicit neural representations that can be used to reproduce a set of training shapes 230 corresponding to facial expressions of a certain face. In another example, model learning module 118 may use anatomical implicit model 200 to learn expressions, postures, and/or deformations associated with a body, body part, and/or another type of deformable object with a specific identity (e.g., a specific person or animal).

As shown in FIG. 2, shapes learned by anatomical implicit model 200 for a given object include a baseline shape 220 for the object and/or a deformed shape 216 for the object. Baseline shape 220 includes a “default” shape for the object, and deformed shape 216 includes a shape for the same object that differs from baseline shape 220. For example, baseline shape 220 may correspond to a face in a neutral expression, while deformed shape 216 may correspond to same face in a non-neutral (e.g., laughing, smiling, frowning, angry, perplexed, yawning, etc.) facial expression. In another example, baseline shape 220 may correspond to a body in a “default” pose (e.g., standing upright with arms at the sides), while deformed shape 216 may correspond to the same body in a different (e.g., sitting, running, dancing, crouching, jumping, etc.) pose.

Baseline shape 220 and deformed shape 216 are additionally defined with respect to a set of points 218(1)-218(X) (each of which is referred to individually herein as point 218) included in a template shape 236, where X represents an integer greater than one. Template shape 236 can include a “default” shape from which all other shapes associated with the object are defined. For example, template shape 236 may include baseline shape 220 for the object and/or a “standard” shape that is generated by averaging and/or otherwise aggregating points 218 across multiple (e.g., hundreds or thousands) different versions of the object.

In one or more embodiments, template shape 236 includes a predefined set of points 218 that can be displaced to positions 224(1)-224(X) (each of which is referred to individually herein as position 224) in baseline shape 220 and/or positions 228(1)-228(X) (each of which is referred to individually herein as position 228) in deformed shape 216. For example, points 218 may correspond to hundreds of thousands to millions of vertices that are connected via a set of edges to form a mesh representing template shape 236. Positions 224 of points 218 in baseline shape 220 and/or positions 228 of points 218 in deformed shape 216 may be computed without altering the connectivity associated with points 218 in template shape 236. Thus, a mesh corresponding to baseline shape 220 and/or deformed shape 216 may be created by replacing the positions of points 218 in the mesh representing template shape 236 with corresponding positions 224 in baseline shape 220 and/or positions 228 in deformed shape 216.

To generate baseline shape 220 and/or deformed shape 216 from points 218 in template shape 236, representations of individual points 218 in template shape 236 are provided as input into anatomical implicit model 200. These representations may include numeric indexes, three-dimensional (3D) positions, encodings, and/or other data that can be used to uniquely identify the corresponding points 218.

Given input that includes a representation of each point 218(1)-218(X), a set of one or more baseline shape models 202 in anatomical implicit model 200 generates a set of attributes 222(1)-222(X) (each of which is referred to individually herein as attributes 222) associated with that point 218 in baseline shape 220. A set of one or more deformation models 204 in anatomical implicit model 200 also generates a set of attributes 226(1)-226(X) (each of which is referred to individually herein as attributes 226) associated with that point in a corresponding deformed shape 216.

Attributes 222 generated by baseline shape models 202 for a given point 218 can be used to compute a corresponding position 224 of that point in baseline shape 220. Similarly, attributes 226 generated by deformation models 204 for a given point 218 can be used to compute a corresponding position 228 of that point in deformed shape 216.

In one or more embodiments, attributes 222 and 226 are associated with components of and/or constraints on the anatomy of the object. For example, attributes 222 may include (but are not limited to) a point on a bone, a “normal” vector associated with the point on the bone, and/or a soft tissue thickness associated with a given point 218 on the surface of the object. Attributes 222 may be converted into a corresponding position 224 of that point 218 on the surface of baseline shape 220 using the following:

$${s}_{0} = {b}_{0} + {d}_{0} {n}_{0} \qquad ( 1 )$$

In the above equation, s₀∈R³ represents position 224 of point 218 on the surface of baseline shape 220 S₀, b₀∈R³ represents the corresponding position on an underlying bone (e.g., a skull underneath the surface of a face), d₀∈R represents the soft tissue thickness between the bone and the surface of baseline shape 220 at that point 218, and n₀∈R³ represents a “bone normal” vector from the bone at b₀ to a point on the surface of baseline shape 220 that is separated from b₀ by the soft tissue thickness.

Continuing with the above example, attributes 226 may include (but are not limited to) a jaw bone transformation, skinning weight, and/or corrective displacement associated with a given point 218. These attributes 226 may be converted into a corresponding position 228 of that point 218 on the surface of deformed shape 216 using the following:

$${s}_{i} = LBS ( {s}_{0} , {T}_{b} , k ) + {e}_{i} \qquad ( 2 )$$

In the above equation, LBS refers to a linear blend skinning operation that rigidly transforms the anatomically reconstructed surface point s₀ on baseline shape 220 with a bone transformation T_{b} and a skinning weight k∈R, and eᵢ ∈R³ represents a corrective displacement that is added to the skinned result produced by the linear blend skinning operation to account for deformations that cannot be captured in the linear blend skinning operation. Consequently, the above example can be used to define the anatomy of the object as a rigidly deforming region underneath the surface of the object that is not restricted to the manifold of the skull and jaw bones. This rigidly deforming surface can be learned from the set of anatomical constraints computed between the surface of the object (e.g., the skin) and the underlying bones.

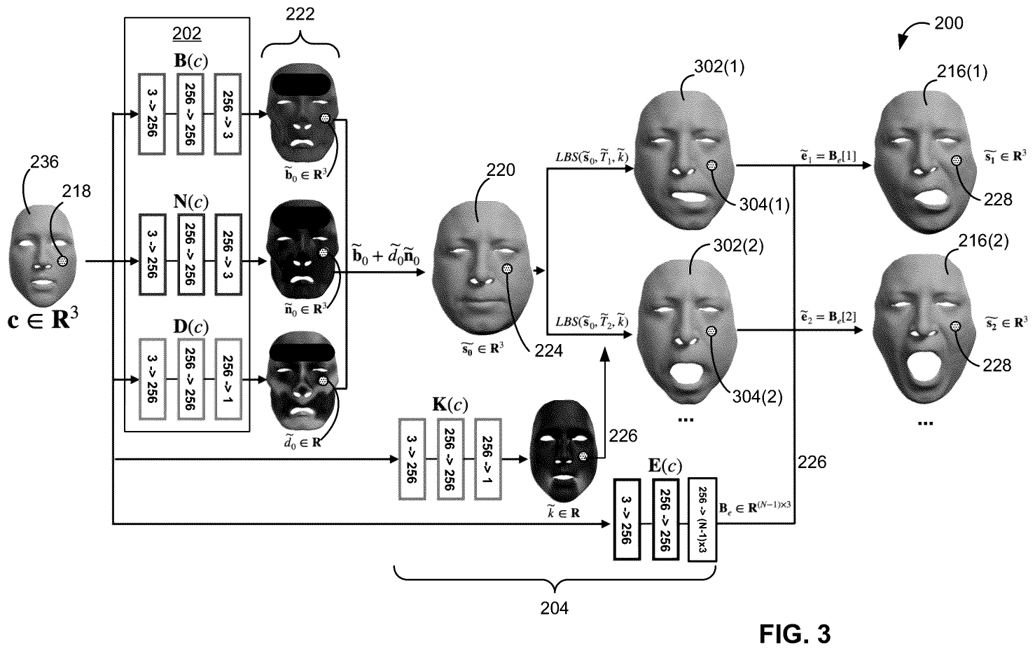

In some embodiments, baseline shape models 202 and deformation models 204 are implemented as neural networks and/or other types of machine learning models. For example, each of baseline shape models 202 and deformation models 204 may include a multi-layer perceptron (MLP) with a sinusoidal, Gaussian error linear unit (GELU), and/or rectified linear unit (ReLU) activation function. Baseline shape models 202 and deformation models 204 are described in further detail below with respect to FIG. 3.

FIG. 3 illustrates an example architecture for anatomical implicit model 200 of FIG. 2, according to various embodiments. Input into anatomical implicit model 200 includes a representation of a certain point 218 on a facial template shape 236, which is denoted by c∈R³ in FIG. 3. This representation is processed by a set of three baseline shape models 202 denoted by B(c), N(c), and D(c). In the example of FIG. 3, each baseline shape model is an MLP with three layers composed of three neurons, 256 neurons, and three neurons, respectively.

Given the inputted point 218 representation, baseline shape models 202 generate predictions of attributes 222 associated with baseline shape 220. These attributes 222 are combined into a predicted position 224 of point 218 on baseline shape 220.

More specifically, the process of predicting position 224 from attributes 222 can be represented by the following:

$${\tilde{b}}_{0} = B ( c ) \qquad ( 3 )$$

$${\tilde{d}}_{0} = D ( c ) \qquad ( 4 )$$

$${\tilde{n}}_{0} = N ( c ) \qquad ( 5 )$$

$${\tilde{s}}_{0} = {\tilde{b}}_{0} + {\tilde{d}}_{0} {\tilde{n}}_{0} \qquad ( 6 )$$

Equations 3, 4, and 5 indicate that baseline shape models 202 B(c), D(c), and N(c) are used to predict attributes 222 that include the bone point \tilde{b}₀∈R³, the soft tissue thickness \tilde{d}₀∈R, and the bone normal ñ₀∈R³ from the bone point toward a point on the surface that is separated from the bone point by the soft tissue thickness, respectively, for point 218. These predicted anatomical attributes 222 are then combined into a predicted position 224 so of point 218 on the surface of baseline shape 220 using Equation 6.

Next, position 224 is converted into additional positions 228 on multiple deformed shapes 216(1)-216(2) using skinning and displacement associated with each deformed shape 216. This skinning and displacement process involves the use of two deformation models 204 denoted by K(c) and E(c) in FIG. 3 to predict an additional set of attributes 226 associated with each deformed shape 216. As with baseline shape models 202, each deformation model in the example of FIG. 3 is an MLP with three layers composed of three neurons, 256 neurons, and three neurons, respectively.

More specifically, the process of predicting position 228 for the ith deformed shape 216 can be represented by the following:

$$\begin{matrix}\tilde{k} = K ( c ) & ( 7 ) \\ {ℬ}_{e} = E ( c ) & ( 8 ) \\ {\tilde{e}}_{i} = {ℬ}_{e} [ i ] & ( 9 ) \\ {\tilde{s}}_{i} = LBS ( {\tilde{s}}_{0} , {\tilde{T}}_{b} , \tilde{k} ) + {\tilde{e}}_{i} & ( 10 )\end{matrix}$$

Equations 7 and 8 indicate that deformation models 204 K(c) and E(c) are used to predict attributes 226 that include the skinning weight \tilde{k}∈R and the corrective displacements basis [symbol] ₑ∈R^{(N-1)×3} for all N−1 deformed shapes 216, respectively. Equation 9 indicates that the corrective displacements for the ith deformed shape 216 are obtained from a corresponding element of [symbol] ₑ. Equation 10 indicates that linear blend skinning is performed using position 224 \tilde{s}₀, skinning weight \tilde{k}, and a jaw bone transformation \tilde{T}_{b}∈R⁹ that includes six degrees of freedom and is optimized during training of baseline shape models 202 and deformation models 204. A predicted position \tilde{s}ᵢ of point 218 on the surface of the ith deformed shape 216 is then computed by adding the corresponding corrective displacement \tilde{e}ᵢ to the linear blend skinning result.

As shown in FIG. 3, the deformation model denoted by K(c) converts the inputted representation of point 218 into the skinning weight \tilde{k}. The linear blend skinning operation is performed two separate times to compute positions 304(1) and 304(2) of point 218 on the surfaces of skinned shapes 302(1) and 302(2) corresponding to deformed shapes 216(1) and 216(2), respectively, from position 224 so, jaw bone transformations \tilde{T}₁ and \tilde{T}₂, and the skinning weight \tilde{k}. The deformation model denoted by E(c) separately converts the inputted representation of point 218 into corrective displacements \tilde{e}₁ and \tilde{e}₂. The first corrective displacement is added to position 304(1) to produce a corresponding position 228 of point 218 on the first deformed shape 216(1), and the second corrective displacement is added to position 304(2) to produce a corresponding position 228 of point 218 the second deformed shape 216(2).

While the example anatomical implicit model 200 is depicted in FIG. 2 as including three baseline shape models 202 and two deformation models 204, it will be appreciated that anatomical implicit model 200 may include various numbers, types, and/or combinations of machine learning models that are used to predict attributes related to positions 224 and/or 228 of a given point 218 on one or more shapes associated with the object. For example, anatomical implicit model 200 may include a machine learning model that predicts multiple types of attributes 222 and/or 226 for a single shape and/or multiple shapes of the object. In another example, anatomical implicit model 200 may include additional machine learning models beyond the three baseline shape models 202 and two deformation models 204 illustrated in FIG. 2. These additional machine learning models may be used to predict jaw bone transformations and/or other attributes that can be used to compute and/or deform positions of points on one or more shapes of the object. In a third example, baseline shape models 202, deformation models 204, and/or other machine learning models in anatomical implicit model 200 may include convolutional neural networks (CNNs), residual neural networks, graph neural networks, transformer neural networks, and/or other types of neural network and/or machine learning architectures.

Returning to the discussion of FIG. 2, training engine 122 in model learning module 118 trains anatomical implicit model 200 using training data 214 that includes a set of training shapes 230. In one or more embodiments, each of training shapes 230 includes a mesh, point cloud, and/or another representation of a set of points with known spatial correspondence. For example, training shapes 230 may be generated using high-resolution 3D scans, motion capture data, and/or other point-based representations of faces, hands, bodies, and/or other objects. Points 232 in each of training shapes 230 may correspond to points 218 in template shape 236 and/or have the same connectivity as points 218 in template shape 236.

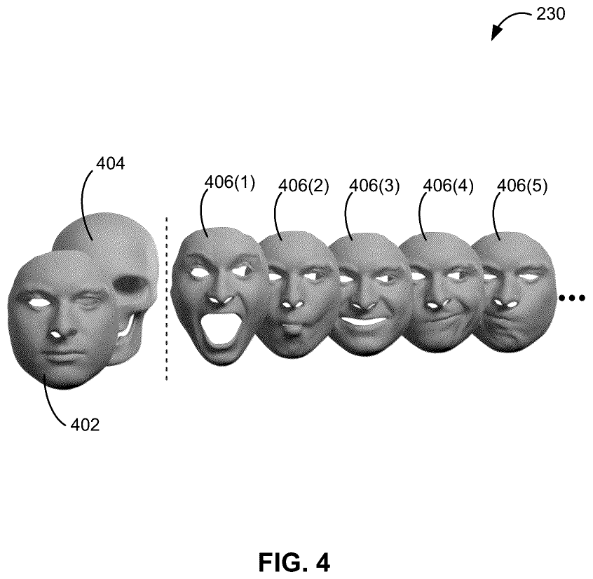

FIG. 4 illustrates an example set of training shapes 230 for anatomical implicit model 200 of FIG. 2, according to various embodiments. As shown in FIG. 4, training shapes 230 include a training baseline shape 402 that depicts a neutral facial expression on a particular face. Training shapes 230 also include a training bone geometry 404 for the skull associated with the face. Bone geometry 404 may be determined by deforming and fitting a template skull and jaw inside baseline shape 402 and/or via another technique.

Training shapes 230 additionally include a set of training deformed shapes 406(1)-406(5) (each of which is referred to individually herein as training deformed shape 406). Training deformed shapes 406 correspond to non-neutral facial expressions of the same face as the neutral facial expression represented by training baseline shape 402. For example, training deformed shapes 406 may depict facial expressions associated with surprise, disgust, anger, happiness, fear, amusement, and/or other emotions or states.

Returning to the discussion of FIG. 2, training engine 122 inputs representations of points 232 from training shapes 230 into baseline shape models 202 and deformation models 204 included in anatomical implicit model 200. Training engine 122 uses baseline shape models 202 to generate training baseline attributes 208 associated with training baseline shapes (e.g., training baseline shape 402 of FIG. 4) included in training shapes 230. Training engine 122 also uses deformation models 204 to generate training deformation attributes 210 associated with training deformed shapes (e.g., training deformed shapes 406 of FIG. 4) included in training shapes 230. Training engine 122 uses training baseline attributes 208 and training deformation attributes 210 to compute training positions 206 that correspond to predicted positions of points 232 in the training baseline shapes and/or training deformed shapes. Training engine 122 computes a set of losses 212 using training baseline attributes 208, training deformation attributes 210, training positions 206, and/or ground truth positions 234 of points 232 in training shapes 230. Training engine 122 additionally uses a training technique (e.g., gradient descent and backpropagation) to iteratively update parameters of baseline shape models 202 and deformation models 204 in a way that reduces losses 212.

In one or more embodiments, training engine 122 uses multiple losses 212 associated with training baseline attributes 208, training deformation attributes 210, training positions 206, and/or ground truth positions 234 to train baseline shape models 202 and deformation models 204. These losses 212 may include a skin position loss L_{S} that penalizes the difference between training positions 206 corresponding to estimated positions \tilde{s}ᵢ of points 232 on training shapes 230 and the corresponding ground truth positions 234 sᵢ:

$${L}_{S} = {λ}_{S} {‖ {\tilde{s}}_{i} - {s}_{i} ‖}_{2}^{2} \qquad ( 11 )$$

In the above equation, the skin position loss includes an L2 loss that is computed between training positions 206 computed from training baseline attributes 208 and training deformation attributes 210 and corresponding ground truth positions 234 in training shapes 230. The L2 loss is also scaled by a factor λ_{S}.

Losses 212 may also, or instead, include an anatomical regularization loss L_{A} that is computed using sparse anatomical constraints and used to regularize training baseline attributes 208 in areas where the constraints can be accurately computed (e.g., skin regions and/or other surfaces with an underlying bone):

$${L}_{A} = {λ}_{b} {‖ {\tilde{b}}_{0} - {b}_{0} ‖}_{2}^{2} + {λ}_{d} {‖ {\tilde{d}}_{0} - {d}_{0} ‖}_{2}^{2} + {λ}_{n} {‖ {\tilde{n}}_{0} - {n}_{i} ‖}_{2}^{2} \qquad ( 12 )$$

In the above equation, the anatomical regularization loss includes a weighted sum of multiple terms, where each term corresponds to an L2 loss for a given training baseline attribute (e.g., bone point, soft tissue thickness, bone normal) scaled by a corresponding factor. Constraints related to the training baseline attributes can be computed using techniques disclosed in U.S. Pat. No. 9,652,890, entitled “Methods and Systems of Generating an Anatomically-Constrained Local Model for Performance Capture,” which is incorporated by reference herein in its entirety.

Losses 212 may also, or instead, include a thickness regularization loss LD that is used to regularize the predicted soft tissue thickness d in unconstrained regions to remain as small as possible, unless dictated otherwise by the skin position loss:

$${L}_{D} = {λ}_{D}^{Reg} {‖ {\tilde{d}}_{0} ‖}_{2}^{2} \qquad ( 13 )$$

This thickness regularization loss includes a sum of squares of soft tissue thicknesses, which is scaled by a factor of λ_{D}^{Reg}.

Losses 212 may also, or instead, include a symmetry regularization loss L_{sym} that causes predictions of underlying skeletal and/or bone structure by the baseline shape model B to be symmetric. This loss penalizes the difference between the prediction generated by B from a reflection R of a point c and the reflection of a prediction generated by B from the same point:

$${L}_{Sym} = {λ}_{sym} {‖ B ( R ( C ) ) - R ( B ( c ) ) ‖}_{2}^{2} \qquad ( 14 )$$

In the above equation, R is an operator that reflects a point along a plane of symmetry associated with the skeletal and/or bone structure. The symmetry regularization loss is computed as an L2 loss that is scaled by a factor λ_{sym}. The symmetry regularization loss can be omitted for predictions of soft tissue thickness, bone normal, and/or other training baseline attributes 208 to allow anatomical implicit model 200 to learn representations of asymmetric objects.

Losses 212 may also, or instead, include a skinning weight regularization loss L_{K} that encourages the estimated skinning weights \tilde{k} in areas that are guaranteed to not be affected by the rigid deformation of the jaw bone to be zero:

$${L}_{K} = {λ}_{k} {‖ K ( {c}^{*} ) ‖}_{2}^{2} \qquad ( 15 )$$

In the above equation, c* denotes one or more regions (e.g., the forehead) on template shape 236 C that are not affected by the rigid deformation of the jaw bone. Further, the skinning weight loss is computed as a sum of squares of skinning weights for the region(s) scaled by a factor of λ_{K}.

In some embodiments, the above losses 212 are summed to produce an overall energy L_{Model}:

$${L}_{Model} = {L}_{S} + {L}_{A} + {L}_{D} + {L}_{Sym} + {L}_{K} \qquad ( 16 )$$

This energy is minimized using gradient descent to train baseline shape models 202 and deformation models 204 in an end-to-end fashion, so that baseline shape models 202 learn, on a per-point basis, the bone structure, soft tissue thickness, and/or other anatomical attributes 222 of a given training baseline shape for the object and deformation models 204 learn skinning weights, corrective displacements, and/or other attributes 226 that can be used to convert points on the training baseline shape into corresponding points in the training deformed shapes. This energy may also, or instead, be used to optimize parameters of the jaw bone transformation \tilde{T}_{b}.

After training of anatomical implicit model 200 is complete, execution engine 124 in model learning module 118 can execute the trained anatomical implicit model 200 to reproduce training shapes 230 and/or points 232 in training shapes for a corresponding object. For example, execution engine 124 may input representations of individual points 218 in template shape 236 into baseline shape models 202 to produce corresponding attributes 222 (e.g., bone points, bone normals, soft tissue thicknesses, etc.) associated with the same points 218 within baseline shape 220. Execution engine 124 may also input the representations of these points 218 into deformation models 204 to produce corresponding attributes 226 (e.g., skinning weights, corrective displacements, etc.) associated with the same points 218 within a given deformed shape 216. Execution engine 124 may then use Equation 6 to compute positions 224 of points 218 in baseline shape 220 from the corresponding attributes 222. Execution engine 124 may similarly use Equation 10 to compute positions 228 of points 218 in deformed shape 216 from the corresponding attributes 226. Finally, execution engine 124 may use positions 224 and/or positions 228 generate a point cloud, mesh, and/or another 3D representation of baseline shape 220, deformed shape 216, and/or another shape associated with the object.

In one or more embodiments, the trained anatomical implicit model 200 is used to perform reconstruction, modeling, deformation, fitting to landmarks, retargeting, and/or other operations related to the set of shapes learned by baseline shape models 202 and/or deformation models 204. For example, positions 224 and/or 228 outputted by anatomical implicit model 200 may be used by model fitting module 120 to generate new shapes for the same object, as described in further detail below with respect to FIGS. 6-9.

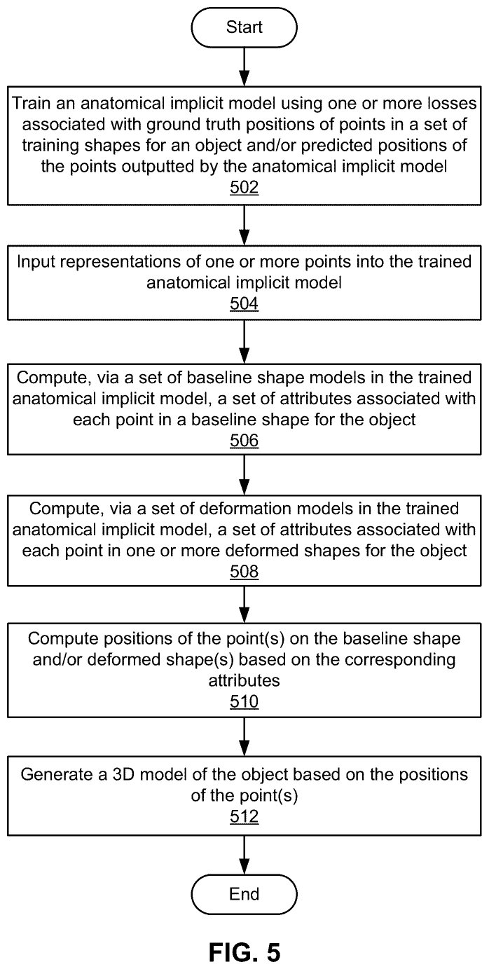

FIG. 5 is a flow diagram of method steps for generating a shape model, according to various embodiments. Although the method steps are described in conjunction with the systems of FIGS. 1-2, persons skilled in the art will understand that any system configured to perform the method steps in any order falls within the scope of the present disclosure.

As shown, in step 502, training engine 122 trains an anatomical implicit model using one or more losses associated with ground truth positions of points in a set of training shapes for an object and/or predicted positions of the points outputted by the anatomical implicit model. For example, training engine 122 may input a representation of each point into a set of baseline shape models and/or a set of deformation models included in the anatomical implicit model. Training engine 122 may use predictions of attributes generated by the baseline shape models and/or deformation models to compute positions of the points in a baseline shape and/or one or more deformed shapes for the object. Training engine 122 may then compute the loss(es) as a set of differences between the set of positions and a set of ground truth positions of the set of points, an anatomical regularization loss associated with anatomical constraints related to the attributes, a thickness regularization loss associated with a soft tissue thickness outputted by one or more baseline shape models, a symmetry regularization loss associated with a symmetry of a skeletal structure within the object, and/or a skinning weight regularization loss associated with skinning weights for the points. Training engine 122 may additionally use a training technique (e.g., gradient descent and backpropagation) to iteratively update weights of the baseline shape models and/or deformation models in a way that reduces the loss(es).

In step 504, execution engine 124 inputs representations of one or more points into the trained anatomical implicit model. For example, execution engine 124 may input unique identifiers, positions, encodings, and/or other representations of individual points in a template shape into the trained anatomical implicit model.

In step 506, execution engine 124 computes, via a set of baseline shape models in the trained anatomical implicit model, a set of attributes associated with each point in a baseline shape for the object. For example, execution engine 124 may use one or more neural networks included in the baseline shape models to generate predictions of a bone point position, bone normal, and/or soft tissue thickness for each point in the baseline shape.

In step 508, execution engine 124 computes, via a set of deformation models in the trained anatomical implicit model, a set of attributes associated with each point in one or more deformed shapes for the object. For example, execution engine 124 may use one or more neural networks included in the deformation models to generate predictions of a jaw bone transformation, skinning weight, and/or corrective displacement for each point in a corresponding deformed shape.

In step 510, execution engine 124 computes positions of the point(s) on the baseline shape and/or deformed shape(s) based on the corresponding attributes. For example, execution engine 124 may combine the bone point, bone normal, and/or soft tissue thickness predicted by the baseline shape models for a given point into a position of the point in the baseline shape. Execution engine 124 may use a linear blend skinning technique to convert the position of the point in the baseline shape, the jaw bone transformation predicted by the deformation models, and a skinning weight predicted by the deformation models into a position of the point in a skinned shape. Execution engine 124 may then compute a position of the point in a deformed shape by adding the corrective displacement predicted by the deformation models to the position of the point in the skinned shape.

In step 512, execution engine 124 generates a 3D model of the object based on the positions of the point(s). For example, execution engine 124 may use the positions of the point to construct a mesh, point cloud, and/or another 3D representation of the baseline shape, deformed shape(s), and/or other shapes associated with the object.

### Shape Reconstruction and Editing Using Anatomically Constrained Implicit Models

FIG. 6 is a more detailed illustration of model fitting module 120 of FIG. 1, according to various embodiments. In some embodiments, model fitting module 120 is configured to train and execute a fitting model 600 to generate parameters 626(1)-626(X) (each of which is referred to individually herein as parameter 626) that are used to convert representations of a set of shapes for an object generated by a preexisting shape model 640 into a fitted shape 616 for the same object.

Target shape 630 includes a partial or full shape that is used as a reference for generating fitted shape 616. For example, target shape 630 may include a desired geometry for one or more portions of fitted shape 616, a desired deformation (e.g., facial expression, pose, etc.) of the object, and/or other attributes to be incorporated into fitted shape 616.

Shape model 640 includes a model that can be used to reproduce and/or combine a set of shapes for the object. For example, shape model 640 may include anatomical implicit model 200 of FIG. 2, a blendshape model for the object, a different type of machine learning model that is capable of predicting positions and/or attributes of shapes for the object, and/or another source of 3D anatomy and/or geometry information for the object. To generate fitted shape 616, model fitting module 120 may use parameters 626 outputted by fitting model 600 to “fit” positions and/or attributes of points in shapes generated by shape model 640 to corresponding positions 628(1)-628(X) (each of which is referred to individually herein as position 628) in fitted shape 616.

As with baseline shape 220 and deformed shape 216 of FIG. 2, target shape 630 and fitted shape 616 are defined with respect to a set of predefined points 218 included in template shape 236. Additionally, points 218 in template shape 236 can be displaced (e.g., using parameters 626) to corresponding positions 628 in fitted shape 616 without altering the connectivity associated with points 218 in template shape 236.

In one or more embodiments, the use of parameters 626 outputted by fitting model 600 to compute positions 628 of points 218 in fitted shape 616 corresponding to a face is represented by the following:

$${s}^{*} = {T}_{g}^{*} ( LBS ( {\tilde{s}}_{0} , {T}_{b}^{*} , \tilde{k} ) + {\sum }_{N - 1} {w}^{*} {B}_{e} ) \qquad ( 17 )$$

In the above equation, s* represents position 628 of a given point 218 on fitted shape 616. This position 628 is computed using attributes (e.g., attributes 222 and/or 226 of FIG. 2) that include a corresponding position \tilde{s}₀ of the point on a baseline shape for the same object, a skinning weight \tilde{k}, and a set of corrective displacements Bₑ associated with a set of deformed shapes of the same object. Values of \tilde{s}₀, \tilde{k}, and Bₑ may be provided by anatomical implicit model 200, a different set of machine learning models, a blendshape model, and/or another source of data for the set of shapes. This position 628 is additionally computed using parameters 626 that include a jaw bone transformation T_{b}*∈R⁹, coefficients w*∈R^{N-1} that are used to blend the corrective displacements, and an optional global head transformation T_{g}*∈R⁹. The jaw bone transformation T_{b}* and/or global head transformation T_{g}* may be predicted using a transform model 602 in fitting model 600, and the blending coefficients w* may be predicted using a blending model 604 in fitting model 600.

In some embodiments, parameters 626 are generated by fitting model 600 based on a set of constraints 624(1)-624(Z) (each of which is referred to individually herein as constraint 624) associated with target shape 630. Constraints 624 include values of attributes associated with target shape 630 that should be reflected in fitted shape 616.

As shown in FIG. 6, execution engine 134 in model fitting module 120 determines constraints 624 from a frame 620 associated with target shape 630. Frame 620 may include a visual, geometric, and/or another representation of target shape 630 at a certain point in time. For example, frame 620 may be included in a sequence of video frames that depict a performance associated with the object (e.g., a facial performance of a person corresponding to the object). In this example, constraints 624 may include 2D landmarks in frame 620 that correspond to points 218 in target shape 630. In another example, frame 620 may be a 3D scan that is included in a sequence of 3D scans generated while the object moves and/or is deformed. In this example, constraints 624 may include 3D positions of one or more points 218 in target shape 630, which are generated by deforming template shape 236 (e.g., using a mesh registration technique) so that vertices in the deformed template shape 236 match points in the 3D scan. In a third example, constraints 624 may be associated with target shape 630 for a different object (e.g., a facial expression on a different face) than the object represented by fitted shape 616.

Training engine 132 in model fitting module 120 uses constraints 624 to compute ground truth positions 634 associated with one or more points 632 in target shape 630. For example, training engine 132 may set ground truth positions 634 for 2D landmarks in a video frame 620 to the locations of the nearest pixels in the video frame 620. In another example, training engine 132 may obtain ground truth positions 634 as 3D positions of a deformed template shape 236 corresponding to a 3D scan of target shape 630.

Training engine 132 also trains fitting model 600 using training data 614 that includes one or more points 632 on target shape 630 and ground truth positions 634 of points 632. As shown in FIG. 6, training engine 132 inputs representations of individual points 632 and a frame code 642 associated with frame 620 into transform model 602 and/or blending model 604. Training engine 132 uses transform model 602 to generate one or more training transforms 608 associated with the jaw, head, and/or another anatomical component of target shape 630. Training engine 132 also uses blending model 604 to generate training coefficients 610 associated with corrective displacements of points 632 in target shape 630. Training engine 132 combines training transforms 608 and training coefficients 610 with attributes generated by shape model 640 for the same points 632 into training positions 606 that correspond to predicted positions of points 632 in target shape 630. Training engine 132 computes a set of losses 612 using training transforms 608, training coefficients 610, training positions 606, and/or ground truth positions 634 of points 232 in target shape 630. Training engine 132 additionally uses a training technique (e.g., gradient descent and backpropagation) to iteratively update parameters of transform model 602 and blending model 604 in a way that reduces losses 612.

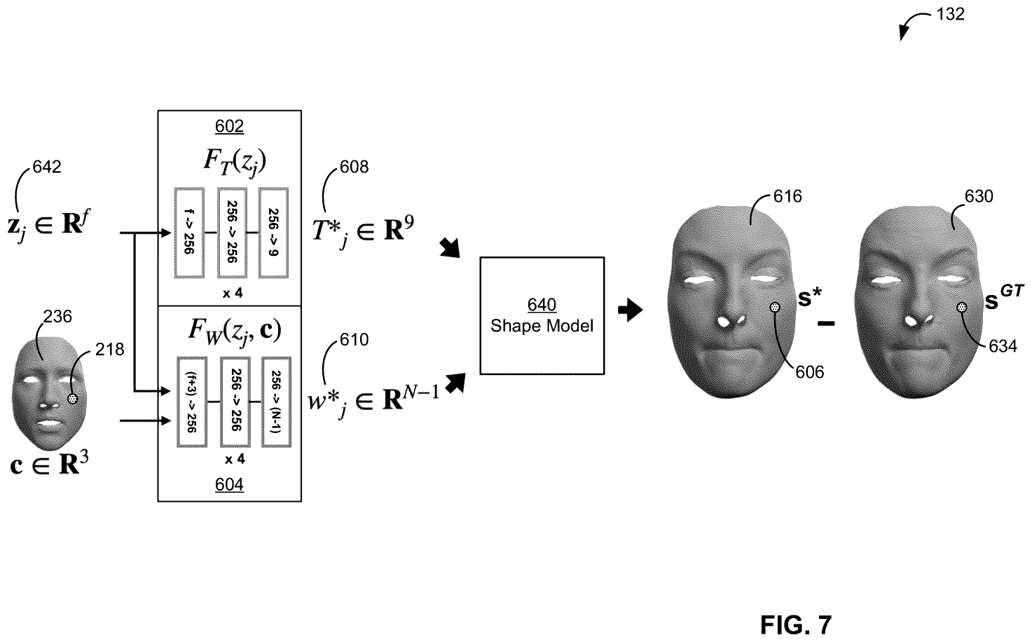

In some embodiments, transform model 602 and blending model 604 include one or more neural networks and/or other types of machine learning models. For example, transform model 602 and blending model 604 may each include a multi-layer perceptron (MLP) with a sinusoidal, Gaussian error linear unit (GELU), and/or rectified linear unit (ReLU) activation function. Transform model 602 and blending model 604 are described in further detail below with respect to FIG. 7.

FIG. 7 illustrates how training engine 132 of FIG. 6 trains fitting model 600, according to various embodiments. As shown in FIG. 7, a vector corresponding to frame code 642 zⱼ∈R^{f} for the jth frame 620 is inputted into both transform model 602 and blending model 604. Input into blending model 604 additionally includes a representation of a certain point 218 on a facial template shape 236, which is denoted by c∈R³ in FIG. 7.

In the example of FIG. 7, transform model 602 and blending model 604 each include an MLP. The MLP corresponding to transform model 602 is denoted by F_{T}(zⱼ) and includes an input layer with f neurons, four hidden layers of 256 neurons each, and an output layer with nine neurons. The MLP corresponding to blending model 604 is denoted by F_{W}(zⱼ, c) and includes an input layer with (f+3) neurons, four hidden layers of 256 neurons each, and an output layer with N−1 neurons, where N denotes the number of deformed shapes associated with shape model 640.

Given the inputted frame code 642, transform model 602 generates training transforms 608 Tⱼ*∈R⁹. For example, training transforms 608 may include a predicted head transformation T_{g}^{j} and a predicted jaw bone transformation T_{b}^{j} associated with the facial template shape 236:

$$[ {T}_{g}^{j} , {T}_{b}^{j} ] = {F}_{T} ( {z}_{j} ) \qquad ( 18 )$$

Given the inputted frame code 642 and representation of point 618, blending model 604 generate training coefficients 610 wⱼ*∈R^{N-1}:

$${w}_{j}^{*} = {F}_{W} ( {z}_{j} , c ) \qquad ( 19 )$$

The jaw bone transform and training coefficients 610 are combined with attributes outputted by shape model 640 for the same point 618 (e.g., using Equation 17) into a corresponding training position 606 s* for point 618 on fitted shape 616. Transform model 602 and blending model 604 are then trained using one or more losses 612 computed from training position 606, a corresponding ground truth position 634 s^{GT} for the same point 618 in target shape 630, training transforms 608, training coefficients 610, and/or frame code 642.

Returning to the discussion of FIG. 6, training engine 132 can use multiple losses 612 associated with training positions 606, ground truth positions 634, training transforms 608, training coefficients 610, and/or frame code 642 to train transform model 602 and blending model 604. These losses 212 may include a 3D position loss L_{Pos}^{3D} that is used to minimize differences between training positions 606 s* and the corresponding ground truth positions 634 s^{GT}:

$${L}_{Pos}^{3 D} = {λ}_{3 D} ( {‖ {s}^{*} - {s}^{GT} ‖}_{2}^{2} + {‖ {s}_{lbs}^{*} - {s}^{GT} ‖}_{2}^{2} ) \qquad ( 20 )$$

To prevent corrective displacements from overcompensating for positions s_{lbs}* in the skinned shape, the 3D position loss is also used to minimize differences between these positions in the skinned shape and the corresponding ground truth positions 634. The sum of the two Euclidean distances is scaled by a factor λ_{3D}.

Losses 612 may also, or instead, include a 2D position loss that is used to minimize differences between projections of training positions 606 s* onto a “screen space” associated with a 2D frame 620 depicting target shape 630 (e.g., using known camera parameters ψ) and the 2D positions p∈R² of the corresponding landmarks:

$${L}_{Pos}^{2 D} = {λ}_{2 D} ( {‖ ψ ( {s}^{*} ) - p ‖}_{2}^{2} + {‖ ψ ( {s}_{lbs}^{*} ) - p ‖}_{2}^{2} ) \qquad ( 21 )$$

As with the 3D position loss, the 2D position loss is also used to minimize differences between projections of positions in the skinned shape onto the screen space and the 2D positions of the corresponding landmarks. The sum of the two Euclidean distances is scaled by a factor λ_{2D}.

Losses 612 may also, or instead, include a coefficient regularization loss that includes an L2 regularization term for training coefficients 610:

$${L}_{W} = {λ}_{Reg}^{w} {‖ {w}^{*} ‖}_{2}^{2} \qquad ( 22 )$$

The L2 regularization term is scaled by a factor λ_{Reg}^{w} to control the effect of the regularization on training coefficients 610.

Losses 612 may also, or instead, include a temporal regularization loss associated with frame code 642:

$${L}_{T} = {λ}_{Reg}^{t} {‖ {z}_{j} - {z}_{j - 1} ‖}_{2}^{2} \qquad ( 23 )$$

More specifically, the temporal regularization loss includes an L2 loss that is used to increase the similarity between frame codes for adjacent frames j and j−1 that are temporally related (e.g., frames from the same performance). The L2 loss is scaled by a factor λ_{Reg}^{t}.

In some embodiments, the above losses 612 are summed to produce an overall energy L_{Fitting}:

$${L}_{Fitting} = {L}_{Pos}^{3 D} + {L}_{Pos}^{2 D} + {L}_{W} + {L}_{T} \qquad ( 24 )$$

This energy is minimized using gradient descent to train transform model 602 and blending model 604, so that transform model 602 learns anatomical transformations that can be applied to shapes from shape model 640 to satisfy constraints 624 associated with target shape 630 and blending model 604 learns, on a per-point basis, blending coefficients that can be combined with corrective displacements from shape model 640 to satisfy constraints 624 associated with target shape 630.

After training of fitting model 600 is complete, execution engine 134 can execute the trained fitting model 600 generate fitted shape 616 for the object. For example, execution engine 124 may input representations of individual points 218 in template shape 236 into shape model 640 to produce corresponding attributes (e.g., bone points, bone normal, soft tissue thicknesses, etc.) associated with the same points 218 within a baseline shape and/or one or more deformed shape 216. Execution engine 124 may also input the point representations and/or optimized frame code 642 into transform model 602 and blending model 604 to produce parameters 626 that reflect constraints 624. Execution engine 124 may then use Equation 17 to compute positions 628 of points 218 in fitted shape 616 from the corresponding attributes and parameters 626. Finally, execution engine 124 may use positions 628 to generate a point cloud, mesh, and/or another 3D representation of fitted shape 616.

As mentioned above, fitted shape 616 can be generated to perform various types of reconstruction, modeling, deformation, fitting to landmarks, retargeting, and/or other operations related to the set of shapes learned by shape model 640. In some embodiments, fitted shape 616 is used to reconstruct a 3D representation of target shape 630 by training fitting model 600 using losses 612 that (i) include a 3D position loss computed between a set of 3D ground truth positions 634 in target shape 630 and a corresponding set of 3D training positions 606 computed using training transforms 608 and training coefficients 610 and (ii) omit the 2D position loss (e.g., by setting 120 to 0).

In other embodiments, fitted shape 616 is used to fit the object to a set of landmarks in a 2D frame 620 depicting target shape 630. In these embodiments, fitting model 600 is trained using losses 612 that (i) include the 2D position loss between projections of training positions 606 onto a screen space associated with the 2D frame 620 and corresponding positions of the landmarks within the 2D frame 620 and (ii) omit the 3D position loss (e.g., by setting λ_{3D} to 0).

In other embodiments, fitted shape 616 is used to perform performance retargeting, in which an animation is transferred from a source object (e.g., a first face) to a target object (e.g., a second face) while respecting the identity and anatomical characteristics of the target object. In these embodiments, separate instances of shape model 640 are learned for the source object and target object, respectively. Fitting model 600 is then trained to fit shapes outputted by shape model 640 for the source object to individual frames within the animation of the source object. Per-frame transformations [T_{g}^{j}, T_{b}^{j}] and blending coefficients wⱼ* generated by the trained fitting model 600 can then be applied to shape model 640 for the target object to generate an animation of the target object, where each frame in the animation of the target object includes deformations (e.g., facial expressions) of the target object that match those of the source object in a corresponding frame within the animation of the source object.

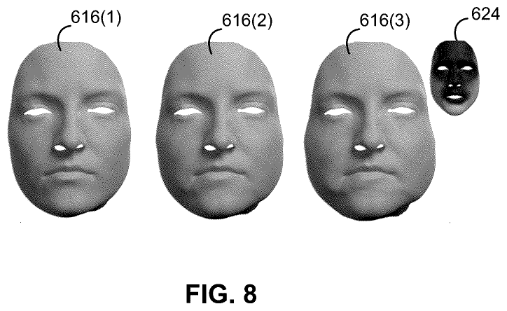

In other embodiments, fitted shape 616 is generated based on modifications to the anatomy associated with the object. For example, fitted shape 616 may be generated in response to edits to the soft tissue thickness in desired regions of the object, as described in further detail below with respect to FIG. 8.

FIG. 8 illustrates an example set of fitted shapes 616(1)-616(3) associated with modifications to an anatomy of an object, according to various embodiments. As shown in FIG. 8, the modifications are associated with constraints 624 that identify a region of the object. For example, constraints 624 may include a “hand painted” region corresponding to the cheeks on a face.

Constraints 624 can be combined with changes to the soft tissue thicknesses in the region to produce fitted shapes 616(1)-616(3). For example, fitted shapes 616(1), 616(2), and 616(3) may be produced using soft tissue thicknesses that are multiplied by increasingly large scaling factors. The scaling factors may be specified by an artist and/or another type of user to sculpt and/or deform the anatomy and/or shape of the face in an interactive manner.

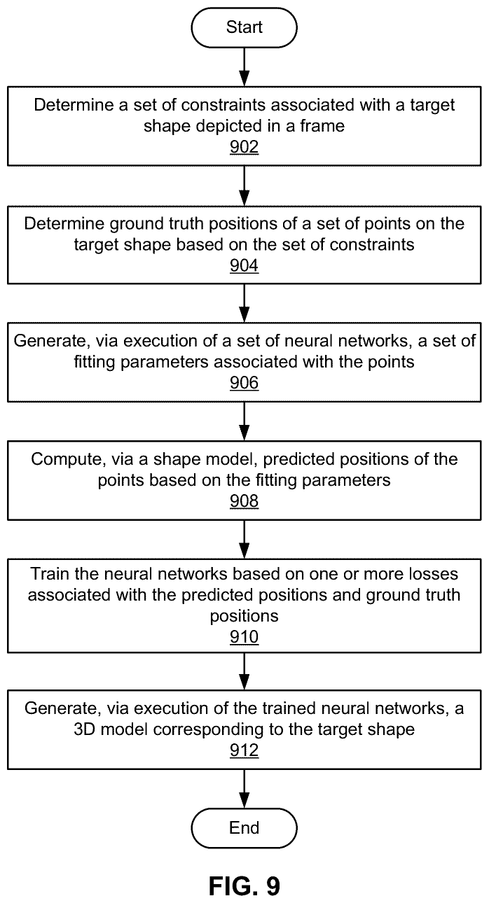

FIG. 9 is a flow diagram of method steps for fitting a shape model for an object to a set of constraints associated with a target shape, according to various embodiments. Although the method steps are described in conjunction with the systems of FIGS. 1 and 6, persons skilled in the art will understand that any system configured to perform the method steps in any order falls within the scope of the present disclosure.

As shown, in step 902, execution engine 134 determines a set of constraints associated with a target shape depicted in a frame. For example, execution engine 134 may determine and/or receive the constraints as 2D landmarks, 3D points, changes to anatomical attributes, regions of the target shape, and/or other values of attributes to be incorporated into a fitted shape.

In step 904, training engine 132 determines ground truth positions of a set of points on the target shape based on the set of constraints. Continuing with the above example, execution engine 134 may determine the ground truth positions as 2D positions of the 2D landmarks within an image corresponding to the frame. Execution engine 134 may also, or instead, determine the ground truth positions as 3D positions of the 3D points within a mesh corresponding to a deformation of a template shape to match a 3D scan corresponding to the frame.

In step 906, training engine 132 generates, via execution of a set of neural networks, a set of fitting parameters associated with the points. For example, training engine 132 may input a latent frame code representing the frame and/or representations of the points into the neural networks. Training engine 132 may execute the neural networks to generate fitting parameters that include (but are not limited to) a jaw bone transformation, head transformation, and/or set of blending coefficients.

In step 908, training engine 132 computes, via a shape model, predicted positions of the points based on the set of fitting parameters. For example, training engine 132 may use an anatomical implicit model and/or another source of information associated with a set of shapes for an object to generate a set of attributes associated with the shapes. Training engine 132 may also use a linear blend skinning technique to combine the attributes and the fitting parameters into the predicted positions.

In step 910, training engine 132 trains the neural networks based on one or more losses associated with the predicted positions and ground truth positions. For example, training engine 132 may compute a temporal regularization loss associated with the frame code and an additional frame code that is temporally related to the frame code, a position loss between the predicted positions (or projections of the predicted positions onto a 2D screen space associated with the frame) and the ground truth positions, and/or a coefficient regularization loss associated with blending coefficients in the fitting parameters. Training engine 132 may then use a training technique (e.g., gradient descent and backpropagation) to iteratively update weights of the neural networks and the frame code in a way that reduces the loss(es).

In step 912, execution engine 134 generates, via execution of the trained neural networks, a 3D model corresponding to the target shape. For example, execution engine 134 may use the trained neural networks and shape model to predict positions of the points in a fitted shape for the object. Execution engine 134 may also use the predicted positions to generate a mesh, point cloud, and/or another 3D model of the fitted shape. The positions in the 3D model may reflect 2D landmarks, 3D positions, deformations, anatomical modifications, and/or other constraints identified in step 902.

In sum, the disclosed techniques use an anatomical implicit model to learn a set of anatomical constraints associated with a face, body, hand, and/or another type of shape, given a set of three-dimensional (3D) geometries of the shape. The anatomical implicit model includes one or more neural networks that are trained to predict, for a given point on a baseline shape for an object (e.g., a face with a neutral expression), a bone point, a bone normal, a soft tissue thickness, and/or other attributes associated with the anatomy of the object. The anatomical implicit model may also include one or more neural networks that predict skinning weights, corrective displacements, and/or other attributes that reflect a deformation of the baseline shape (e.g., a non-neutral facial expression for the same face). These parameters may then be used to displace the point to a new position corresponding to the deformation.

After training of the anatomical implicit model is complete, the anatomical implicit model is capable of reproducing, on a per-point basis, the deformations in a way that constrains the surface of the shape to the underlying anatomy of the object. More specifically, one or more portions of the trained anatomical implicit model can be used to generate and/or reconstruct additional shapes that adhere to the same anatomical constraints. For example, shapes learned by the anatomical implicit model may be “fitted” to additional constraints associated with a 3D performance by the same object, a 3D performance by a different object, a two-dimensional (2D) position constraint (e.g., a facial landmark), and/or edits to the geometry and/or anatomy of the object. During this fitting process, a fitting model that includes one or more neural networks and/or other types of machine learning models may be used to predict head and/or jaw transformations, per-point blending coefficients, and/or other fitting parameters that are combined with per-point attributes outputted by the anatomical implicit model to generate a new shape for the object.

One technical advantage of the disclosed techniques relative to the prior art is the ability to represent continuous, nonlinear deformations of shapes corresponding to faces and/or other objects. Consequently, the disclosed techniques can be used to generate shapes that reflect a wider range of facial expressions and/or other types of deformations of the shapes than conventional linear 3D morphable models (3DMMs) that express new shapes as linear combinations of prototypical basis shapes. At the same time, because the generated shapes adhere to anatomical constraints associated with the objects, the disclosed techniques can be used to generate shapes that are more anatomically plausible than those produced by 3DMMs. Another technical advantage of the disclosed techniques is the ability to generate anatomically plausible shapes more quickly and efficiently than conventional approaches that iteratively optimize 3DMM parameters using computed anatomical constraints. For example, the disclosed techniques can be used to generate and/or reconstruct a 3D model of a face in a frame of an animation in 2-3 seconds instead of several minutes required by conventional optimization-based approaches. These technical advantages provide one or more technological improvements over prior art approaches.

1. In some embodiments, a computer-implemented method for generating a shape model comprises generating, via execution of a set of neural networks based on a plurality of shapes associated with an object, a set of attributes associated with a set of anatomical constraints for the object; computing, based on the set of attributes, a set of positions of a set of points on the object; and generating a three-dimensional (3D) model of the object based on the set of positions of the set of points.

2. The computer-implemented method of clause 1, further comprising training the set of neural networks based on one or more losses associated with the set of positions.

3. The computer-implemented method of any of clauses 1-2, wherein the one or more losses comprise a set of differences between the set of positions and a set of ground truth positions of the set of points.

4. The computer-implemented method of any of clauses 1-3, wherein the one or more losses comprise an anatomical regularization loss associated with the set of anatomical constraints.

5. The computer-implemented method of any of clauses 1-4, wherein the one or more losses comprise a thickness regularization loss associated with a soft tissue thickness of the object.

6. The computer-implemented method of any of clauses 1-5, wherein the one or more losses comprise a symmetry regularization loss associated with a symmetry of a skeletal structure within the object.

7. The computer-implemented method of any of clauses 1-6, wherein the set of attributes comprises at least one of a bone point, a bone normal, or a soft tissue thickness.

8. The computer-implemented method of any of clauses 1-7, wherein the object comprises a face.

9. The computer-implemented method of any of clauses 1-8, wherein the set of attributes comprises at least one of a jaw bone transformation, a skinning weight, or a residual displacement.

10. The computer-implemented method of any of clauses 1-9, wherein the plurality of shapes comprises a neutral facial expression associated with the face and one or more non-neutral facial expressions associated with the face.

11. In some embodiments, one or more non-transitory computer readable media store instructions that, when executed by one or more processors, cause the one or more processors to perform operations comprises generating, via execution of a set of neural networks based on a plurality of shapes associated with an object, a set of attributes associated with a set of anatomical constraints for the object; computing, based on the set of attributes, a set of positions of a set of points on the object; and generating a three-dimensional (3D) model of the object based on the set of positions of the set of points.

12. The one or more non-transitory computer readable media of clause 11, wherein the operations further comprise training the set of neural networks based on one or more losses associated with the set of positions.

13. The one or more non-transitory computer readable media of any of clauses 11-12, wherein the one or more losses comprise at least one of a set of differences between the set of positions and a set of ground truth positions of the set of points; an anatomical regularization loss associated with the set of anatomical constraints; a thickness regularization loss associated with a soft tissue thickness of the object; a symmetry regularization loss associated with a symmetry of a skeletal structure within the object; or a skinning weight regularization loss associated with a set of skinning weights for the set of points.

14. The one or more non-transitory computer readable media of any of clauses 11-13, wherein generating the set of attributes comprises computing at least one of a bone point, a bone normal, or a soft tissue thickness associated with a point within a baseline shape for the object.

15. The one or more non-transitory computer readable media of any of clauses 11-14, wherein generating the set of attributes comprises computing at least one of a jaw bone transformation, a skinning weight, or a corrective displacement associated with a point within a shape included in the plurality of shapes.

16. The one or more non-transitory computer readable media of any of clauses 11-15, wherein computing the set of positions of the set of points on the object comprises for each point in the set of points, computing a first position of the point on a baseline shape for the object based on a first subset of the set of attributes; and computing a second position of the point on an additional shape included in the plurality of shapes based on the first position of the point and a second subset of the set of attributes.

17. The one or more non-transitory computer readable media of any of clauses 11-16, wherein the second position of the point is computed using a linear blend skinning operation and a corrective displacement associated with the second subset of the set of attributes.

18. The one or more non-transitory computer readable media of any of clauses 11-17, wherein the object comprises a face.

19. The one or more non-transitory computer readable media of any of clauses 11-18, wherein the set of points lie on a surface of the face.

20. In some embodiments, a system comprises one or more memories that store instructions, and one or more processors that are coupled to the one or more memories and, when executing the instructions, are configured to perform operations comprising generating, via execution of a set of neural networks based on a plurality of shapes associated with an object, a set of attributes associated with a set of anatomical constraints for the object; computing, based on the set of attributes, a set of positions of a set of points on the object; and generating a three-dimensional (3D) model of the object based on the set of positions of the set of points.

21. In some embodiments, a computer-implemented method for fitting a shape model for an object to a set of constraints associated with a target shape comprises determining, based on the set of constraints, one or more ground truth positions of one or more points on the target shape; generating, via execution of a set of neural networks, a set of fitting parameters associated with the one or more points; computing, via the shape model, one or more predicted positions of the one or more points based on the set of fitting parameters; training the set of neural networks based on one or more losses associated with the one or more predicted positions and the one or more ground truth positions; and generating, via execution of the trained set of neural networks, a three-dimensional (3D) model corresponding to the target shape.

22. The computer-implemented method of clause 21, wherein determining the one or more ground truth positions comprises deforming a template mesh to match the target shape; and determining the one or more ground truth positions of the one or more points in the template mesh.

23. The computer-implemented method of any of clauses 21-22, wherein the one or more ground truth positions comprise a set of two-dimensional (2D) positions of a set of landmarks associated with an image of the target shape.

24. The computer-implemented method of any of clauses 21-23, wherein generating the set of fitting parameters comprises converting, via execution of the set of neural networks, a frame code associated with the target shape into the set of fitting parameters.

25. The computer-implemented method of any of clauses 21-24, wherein training the set of neural networks comprises updating the frame code and a set of weights included in the set of neural networks based on the one or more losses.

26. The computer-implemented method of any of clauses 21-25, wherein the one or more losses comprise a temporal regularization loss associated with the frame code and an additional frame code that is temporally related to the frame code.

27. The computer-implemented method of any of clauses 21-26, wherein the one or more losses comprise one or more distances between the one or more predicted positions and the one or more ground truth positions.

28. The computer-implemented method of any of clauses 21-27, wherein the one or more losses comprise a coefficient regularization loss associated with a set of blending coefficients included in the set of fitting parameters.

29. The computer-implemented method of any of clauses 21-28, wherein computing the one or more predicted positions of the one or more points comprises generating, via the shape model, a set of attributes associated with a set of learned shapes for the object; and computing the one or more predicted positions based on the set of attributes and the set of fitting parameters.

30. The computer-implemented method of any of clauses 21-29, wherein the set of attributes comprises at least one of a bone point position, a soft tissue thickness, a bone normal, a skinning weight associated, or a set of corrective displacements; and the set of fitting parameters comprises at least one of an anatomical transformation or a set of blending coefficients associated with the set of corrective displacements.

31. In some embodiments, one or more non-transitory computer readable media store instructions that, when executed by one or more processors, cause the one or more processors to perform operations comprises determining one or more ground truth positions of one or more points on a target shape associated with an object; generating, via execution of a set of neural networks, a set of fitting parameters associated with the one or more points; computing, via a shape model, one or more predicted positions of the one or more points based on the set of fitting parameters; training the set of neural networks based on one or more losses associated with the one or more predicted positions and the one or more ground truth positions; and generating, via execution of the trained set of neural networks, a three-dimensional (3D) model corresponding to the target shape.

32. The one or more non-transitory computer readable media of clause 31, wherein generating the set of fitting parameters comprises generating, via execution of a first neural network included in the set of neural networks, one or more transformations associated with an anatomy of the object; and generating, via execution of a second neural network included in the set of neural networks, a set of blending coefficients associated with a set of corrective displacements outputted by the shape model for the one or more points.

33. The one or more non-transitory computer readable media of any of clauses 31-32, wherein the one or more transformations are generated based on a frame code associated with the target shape.

34. The one or more non-transitory computer readable media of any of clauses 31-33, wherein the set of blending coefficients is generated based on (i) a frame code associated with the target shape and (ii) the one or more points.

35. The one or more non-transitory computer readable media of any of clauses 31-34, wherein the 3D model comprises a deformation of a first face via the one or more transformations, and the one or more transformations are determined using a second face corresponding to the target shape.

36. The one or more non-transitory computer readable media of any of clauses 31-35, wherein the 3D model comprises a reconstruction of the target shape.

37. The one or more non-transitory computer readable media of any of clauses 31-36, wherein the 3D model comprises an edit to an anatomy of the object.

38. The one or more non-transitory computer readable media of any of clauses 31-37, wherein the shape model comprises an additional set of neural networks.

39. The one or more non-transitory computer readable media of any of clauses 31-38, wherein the one or more ground truth positions comprise at least one of one or more 3D positions of the one or more points in a mesh associated with the target shape or one or more two-dimensional (2D) positions of the one or more points in an image of the target shape.

40. In some embodiments, a system comprises one or more memories that store instructions, and one or more processors that are coupled to the one or more memories and, when executing the instructions, are configured to perform operations comprising determining one or more ground truth positions of one or more points on a target shape associated with an object; generating, via execution of a set of neural networks, a set of fitting parameters associated with the one or more points; computing, via a shape model, one or more predicted positions of the one or more points based on the set of fitting parameters; training the set of neural networks based on one or more losses associated with the one or more predicted positions and the one or more ground truth positions; and generating, via execution of the trained set of neural networks, a three-dimensional (3D) model corresponding to the target shape.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a shape model, the method comprising:
generating, via execution of a set of neural networks based on a plurality of shapes associated with an object, a set of attributes associated with a set of anatomical constraints for the object;
computing, based on the set of attributes, a set of positions of a set of points on the object; and
generating a three-dimensional (3D) model of the object based on the set of positions of the set of points.

2. The computer-implemented method of claim 1, further comprising training the set of neural networks based on one or more losses associated with the set of positions.

3. The computer-implemented method of claim 2, wherein the one or more losses comprise a set of differences between the set of positions and a set of ground truth positions of the set of points.

4. The computer-implemented method of claim 2, wherein the one or more losses comprise an anatomical regularization loss associated with the set of anatomical constraints.

5. The computer-implemented method of claim 2, wherein the one or more losses comprise a thickness regularization loss associated with a soft tissue thickness of the object.

6. The computer-implemented method of claim 2, wherein the one or more losses comprise a symmetry regularization loss associated with a symmetry of a skeletal structure within the object.

7. The computer-implemented method of claim 1, wherein the set of attributes comprises at least one of a bone point, a bone normal, or a soft tissue thickness.

8. The computer-implemented method of claim 1, wherein the object comprises a face.

9. The computer-implemented method of claim 8, wherein the set of attributes comprises at least one of a jaw bone transformation, a skinning weight, or a residual displacement.

10. The computer-implemented method of claim 8, wherein the plurality of shapes comprises a neutral facial expression associated with the face and one or more non-neutral facial expressions associated with the face.

11. One or more non-transitory computer readable media storing instructions that, when executed by one or more processors, cause the one or more processors to perform operations comprising:
generating, via execution of a set of neural networks based on a plurality of shapes associated with an object, a set of attributes associated with a set of anatomical constraints for the object;
computing, based on the set of attributes, a set of positions of a set of points on the object; and
generating a three-dimensional (3D) model of the object based on the set of positions of the set of points.

12. The one or more non-transitory computer readable media of claim 11, wherein the operations further comprise training the set of neural networks based on one or more losses associated with the set of positions.

13. The one or more non-transitory computer readable media of claim 12, wherein the one or more losses comprise at least one of:
a set of differences between the set of positions and a set of ground truth positions of the set of points;
an anatomical regularization loss associated with the set of anatomical constraints;
a thickness regularization loss associated with a soft tissue thickness of the object;
a symmetry regularization loss associated with a symmetry of a skeletal structure within the object; or
a skinning weight regularization loss associated with a set of skinning weights for the set of points.

14. The one or more non-transitory computer readable media of claim 11, wherein generating the set of attributes comprises computing at least one of a bone point, a bone normal, or a soft tissue thickness associated with a point within a baseline shape for the object.

15. The one or more non-transitory computer readable media of claim 11, wherein generating the set of attributes comprises computing at least one of a jaw bone transformation, a skinning weight, or a corrective displacement associated with a point within a shape included in the plurality of shapes.

16. The one or more non-transitory computer readable media of claim 11, wherein computing the set of positions of the set of points on the object comprises:
for each point in the set of points, computing a first position of the point on a baseline shape for the object based on a first subset of the set of attributes; and
computing a second position of the point on an additional shape included in the plurality of shapes based on the first position of the point and a second subset of the set of attributes.

17. The one or more non-transitory computer readable media of claim 16, wherein the second position of the point is computed using a linear blend skinning operation and a corrective displacement associated with the second subset of the set of attributes.

18. The one or more non-transitory computer readable media of claim 11, wherein the object comprises a face.

19. The one or more non-transitory computer readable media of claim 18, wherein the set of points lie on a surface of the face.

20. A system, comprising:
one or more memories that store instructions, and
one or more processors that are coupled to the one or more memories and, when executing the instructions, are configured to perform operations comprising:
generating, via execution of a set of neural networks based on a plurality of shapes associated with an object, a set of attributes associated with a set of anatomical constraints for the object;
computing, based on the set of attributes, a set of positions of a set of points on the object; and
generating a three-dimensional (3D) model of the object based on the set of positions of the set of points.
